(19) United States
(12) Patent Application Publication
(10) Pub. No.: US 2021/0281530 A1
(43) Pub. Date: Sep. 9, 2021

(54) INSTANT MESSAGE DELIVERY

(71) Applicant: INTERNATIONAL BUSINESS MACHINES CORPORATION, Armonk, NY (US)

(72) Inventors: DONG CHEN, BEIJING (CN); TING TING BJ ZHAN, BEIJING (CN); PENG FEI TIAN, BEIJING (CN); XIAO JUAN CHEN, BEIJING (CN); ZHEN RONG WANG, BEIJING (CN); YE HUO, BEIJING (CN); HUAI YING HY XIA, BEIJING (CN); LI JIA CHEN, WUHAN (CN)

(21) Appl. No.: 16/808,636

(22) Filed: Mar. 4, 2020

(51) Int. Cl. H04L 12/58; G06F 40/30

(52) U.S. Cl. CPC H04L 51/24; H04L 51/26; G06F 40/30

(57) ABSTRACT

Aspects of the invention include receiving an instant message for a user and determining a logical coherence state of user actions. The method also includes determining an importance score for the instant message and for a current user action and determining one or more conditions for displaying the instant message to the user based on the logical coherence state of user actions, the importance score of the instant message and the importance score of the current user action. The method further includes displaying the instant message to the user upon the one or more conditions being met.

### BACKGROUND

The present invention generally relates to instant messaging, and more specifically, to controlling the display of instant messages based on user actions.

Instant messaging applications have become ubiquitous. Currently, when an instant message is received, the instant messaging application displays the instant message, or a notification of the message, to a user in various ways. For example, some instant messaging applications cause an instant message dialog/window pop up directly upon the receipt of a new instant message and others display a notification by making an icon in a taskbar flash. Other means of displaying incoming instant messages are also used, such as a message notification appearing to slide in from the side of the monitor on top of a current application.

Each of the known ways to display incoming instant messages has drawbacks that can make users uncomfortable. For example, popping up an instant messaging box directly can interfere with the current working or learning status of users, and interrupts the users' current actions. In addition, a message application icon flashing in the taskbar can easily be ignored or overlooked by users, resulting in an important message not being viewed in a timely manner.

### SUMMARY

Embodiments of the present invention are directed to controlling instant message notifications. A non-limiting example computer-implemented method includes receiving an instant message for a user and determining a logical coherence state of user actions. The method also includes determining an importance score for the instant message and for a current user action and determining one or more conditions for displaying the instant message to the user based on the logical coherence state of user actions, the importance score of the instant message and the importance score of the current user action. The method further includes displaying the instant message to the user upon the one or more conditions being met.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of a system for controlling instant message notifications according to one or more embodiments of the present invention;

FIG. 2 depicts a flow diagram of a method for controlling instant message notifications according to one or more embodiments of the present invention;

FIG. 3 depicts a block diagram of a set of conditions used for controlling instant message notifications according to one or more embodiments of the present invention;

FIG. 4 depicts a flow diagram of another method for controlling instant message notifications according to one or more embodiments of the present invention; and

FIG. 5 depicts a processing system for controlling instant message notifications according to one or more embodiments of the present invention.

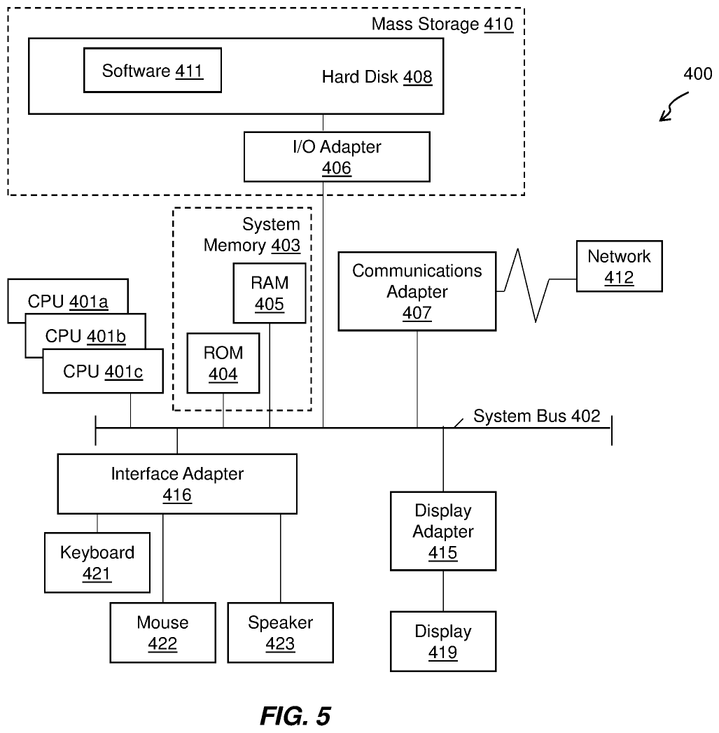

The diagrams depicted herein are illustrative. There can be many variations to the diagrams, or the operations described therein without departing from the spirit of the invention. For instance, the actions can be performed in a differing order or actions can be added, deleted or modified. Also, the term “coupled”, and variations thereof describes having a communications path between two elements and does not imply a direct connection between the elements with no intervening elements/connections between them. All of these variations are considered a part of the specification.

### DETAILED DESCRIPTION

One or more embodiments of the present invention provide methods, systems, and computer program products for controlling instant message notifications. In exemplary embodiments, the manner and timing of displaying instant messages, or instant message notifications, are controlled to minimize interruptions to a user while still providing the user with important messages in a timely manner.

In exemplary embodiments, when an instant message is received, the message is assigned an importance score based on an analysis of the contents of the message and a relationship between the sender of the message and the recipient. In addition, the interactions of the user and open applications are analyzed to identify a logical coherence state of the user actions. Based upon the importance score of the instant message and the logical coherence state of the user actions, a determination is made of when and how to present the instant message to the user. In exemplary embodiments, the determination is based upon a set of user preferences obtain from a user profile, which was previously created by the user.

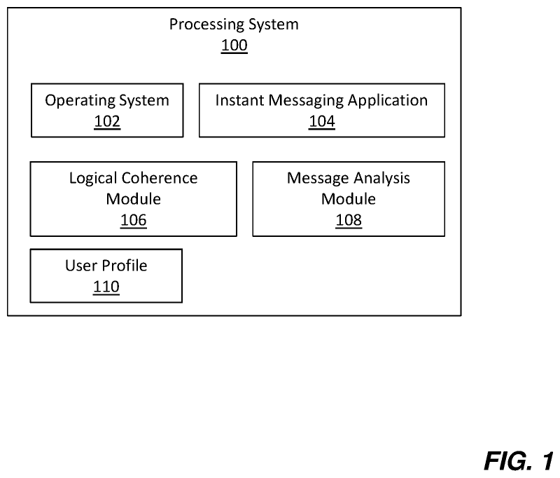

Turning now to FIG. 1, a block diagram of a system 100 for controlling instant message notifications is generally shown in accordance with one or more embodiments of the present invention. As illustrated, the system 100 includes an operating system 102, an instant messaging application 104, a logical coherence module 106, a message analysis module 108, and a user profile 110. In exemplary embodiments, the logical coherence module 106 is configured to monitor the interactions between the user and one or more applications being executed by the operating system 102. The logical coherence module 106 is further configured to determine whether a user is actively using an application and is in the middle of completing a task, such as drafting an email, editing a document, or the like. In exemplary embodiments, the message analysis module 108 is configured to analyze instant messages when the messages are received and to assign an importance score to the instant messages based on the analysis. In exemplary embodiments, the importance score is determined based on an analysis of the text of the message as well as an analysis of the relationship between the sender and recipient of the message. The user profile 110 is configured to store a set of rules, also referred to as a set of conditions, that are used by the instant messaging application 104 to determine when and how to display the instant messages to the user. In exemplary embodiments, the set of conditions in the user profile 110 are set and can be modified by the user.

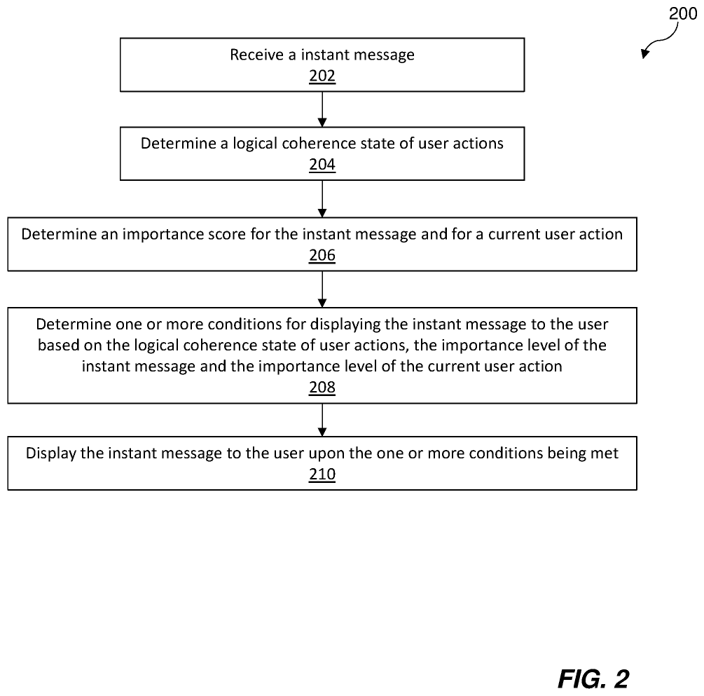

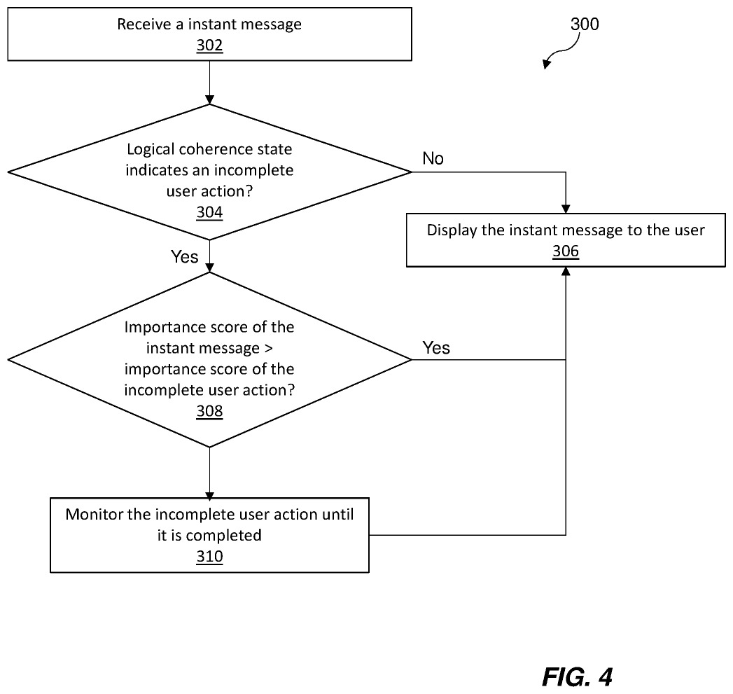

Turning now to FIG. 2, a flow diagram of a method 200 for controlling instant message notifications is generally shown in accordance with one or more embodiments of the present invention. The method 200 shown in FIG. 2 may be executed by an operating system, such as OS 411 of FIG. 4, executing on a computer processor. As shown at block 202, the method 200 includes receiving an instant message for a user. Next, as shown at block 204, the method 200 includes determining a logical coherence state of user actions. In exemplary embodiments, determining the logical coherence state of user actions includes analyzing a state of user interaction with one or more applications. For example, it is determined if the user is actively engaged in a task such as drafting an email or a document, of the user is in the middle of an activity that is not complete, such as the user is attending a web conference or the like. In one embodiment, the logical coherence state of user interaction with one or more applications indicates whether an incomplete user action exists for one or more applications.

Next, as shown at block 206, the method 200 includes determining an importance score for the instant message and for a current user action. In exemplary embodiments, the importance score for an instant message is determined based on an analysis of the text of the instant message as well as an analysis of the relationship between the sender and recipient of the instant message. In exemplary embodiments, the importance score of the current user action is determined based on the type of application being used, and an analysis of the user interaction with the application. In exemplary embodiments, the user profile includes a baseline importance score for the application, which can be increased/decreased based on how the application is being used. For example, an email application has a baseline score that can be increased or decreased based on how it is being used so that a user drafting an email to their boss regarding a project will have a higher importance score that a user drafting an email to a friend regarding a trip.

As shown at block 208, the method 200 also includes determining one or more conditions for displaying the instant message to the user based on the logical coherence state of user actions, the importance score of the instant message and the importance score of the current user action. In exemplary embodiments, the one or more conditions are obtained from a user profile of the user. In an embodiment, one condition is that the importance score of the instant message exceeds an importance score of the current user activity and that the logical coherence state of user actions does not include any incomplete user items. In another embodiment, one condition is that the importance score of the instant message is above a set threshold value. A further condition is that the importance score of the instant message is less than the importance score of the current user action. In an exemplary embodiment, each of the one or more conditions includes a manner and a timeline for displaying the instant message to the user. The method 200 concludes at block 210 by displaying the instant message to the user upon the one or more conditions being met.

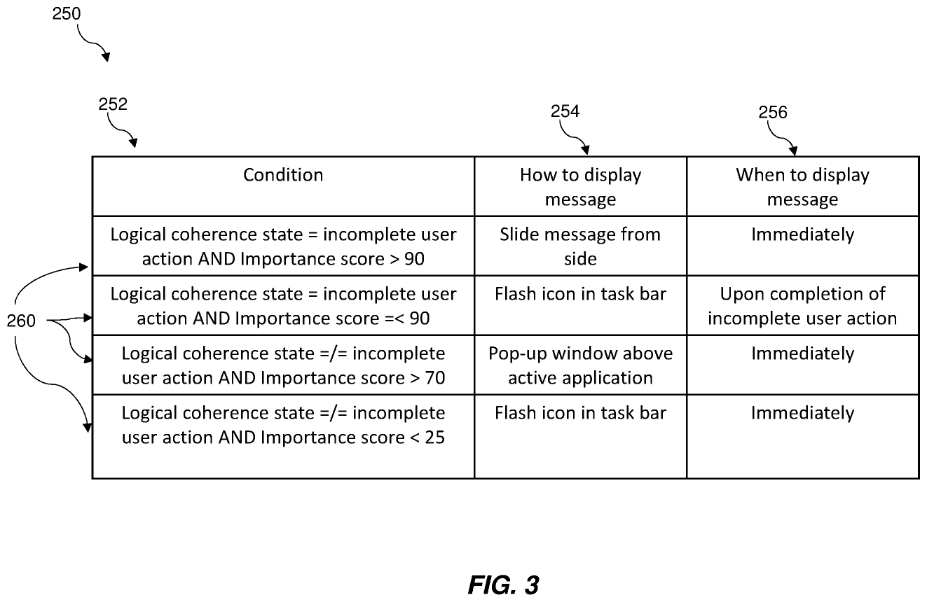

Turning now to FIG. 3 a block diagram of a set of conditions 300 used for controlling instant message notifications according to one or more embodiments of the present invention is shown. As illustrated, each entry 260 includes a condition 252 and an indication of how to display the instant message 254 and when to display the instant message 256 when the condition 252 is met. In exemplary embodiments, a user is able to set and modify the conditions 252. The conditions 252 shown in FIG. 3 are only provided for illustration purposes and it will be clear to those of ordinary skill in the art that a wide variety of conditions other than those shown can be used.

In exemplary embodiments, machine learning methods are used to analyze instant messages and the relationships between a sender and a recipient to determine an importance score for the instant message. For example, a machine learning model may be trained based on a corpus of messages that have importance scores associated with them and when a new message is received, the model would read it and then output a textual importance score for the instant message. In addition, an organizational chart and data extracted from a user's contact database can be used to determine an importance level that will be associated with a sender of an instant message. In exemplary embodiments, the user is able to assign and edit the importance level associated with each sender and store that information in their user profile. The importance score assigned to a message is a function of both the textual importance score and the importance score associated with the sender of the instant message.

Furthermore, in exemplary embodiments, machine learning methods can be used to create and modify the conditions based on observed user behavior. For example, if a user quickly closes an instant message notification without responding and returns to a task the user was previously working on, it can be assumed that the user would have preferred to not receive the instant message notification at that time. Conversely, if the user replies to the instant message or takes an action related to the instant message, it can be assumed that the user would have preferred to receive the instant message notification at that time. In exemplary embodiments, the text and sender of the instant messages and the logical coherence state of user actions when the previous instant messages were received can be used, along with the inferred user display preference, to train a machine learning model that can be applied to incoming messages. In addition, the model can be continuously updated based on observed user behaviors.

Turning now to FIG. 4, a flow diagram of a method 300 for controlling instant message notifications is generally shown in accordance with one or more embodiments of the present invention. The method 300 shown in FIG. 3 may be executed by an operating system, such as OS 411 of FIG. 4, executing on a computer processor. As shown at block 302, the method 300 includes receiving an instant message. Next, as shown at decision block 304, the method 300 includes determining if the logical coherence state indicates an incomplete user action. In exemplary embodiments, the logical coherence state indicates when the user has an incomplete user action, i.e., that the user is in the middle of a task, such as drafting an email or reviewing a document. If the logical coherence state does not indicate an incomplete user action, the method 300 proceeds to block 306 and displays the instant message to the user. Otherwise, the method 300 proceeds to decision block 308 and determines whether an importance score of the instant message is greater than the importance score of the incomplete user action. If the importance score of the instant message is greater than the importance score of the incomplete user action, the method 300 proceeds to block 306 and displays the instant message to the user. Otherwise, the method 300 proceeds to block 310 and monitors the incomplete user action until it is completed, at which point the method 300 proceeds to block 306 and displays the instant message to the user.

In one embodiment, multiple instant messages are not immediately displayed based on one or more conditions not being met and are queued to be displayed at a later time. In this embodiment, the instant messages can be displayed in a first-in-first-out order or the instant messages can be displayed in descending order based upon the importance score assigned to the instant message.

Turning now to FIG. 4, a computer system 400 is generally shown in accordance with an embodiment. The computer system 400 can be an electronic, computer framework comprising and/or employing any number and combination of computing devices and networks utilizing various communication technologies, as described herein. The computer system 400 can be easily scalable, extensible, and modular, with the ability to change to different services or reconfigure some features independently of others. The computer system 400 may be, for example, a server, desktop computer, laptop computer, tablet computer, or smartphone. In some examples, computer system 400 may be a cloud computing node. Computer system 400 may be described in the general context of computer system executable instructions, such as program modules, being executed by a computer system. Generally, program modules may include routines, programs, objects, components, logic, data structures, and so on that perform particular tasks or implement particular abstract data types. Computer system 400 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, the computer system 400 has one or more central processing units (CPU(s)) 401a, 401b, 401c, etc. (collectively or generically referred to as processor(s) 401). The processors 401 can be a single-core processor, multi-core processor, computing cluster, or any number of other configurations. The processors 401, also referred to as processing circuits, are coupled via a system bus 402 to a system memory 403 and various other components. The system memory 403 can include a read only memory (ROM) 404 and a random access memory (RAM) 405. The ROM 404 is coupled to the system bus 402 and may include a basic input/output system (BIOS), which controls certain basic functions of the computer system 400. The RAM is read-write memory coupled to the system bus 402 for use by the processors 401. The system memory 403 provides temporary memory space for operations of said instructions during operation. The system memory 403 can include random access memory (RAM), read only memory, flash memory, or any other suitable memory systems.

The computer system 400 comprises an input/output (I/O) adapter 406 and a communications adapter 407 coupled to the system bus 402. The I/O adapter 406 may be a small computer system interface (SCSI) adapter that communicates with a hard disk 408 and/or any other similar component. The I/O adapter 406 and the hard disk 408 are collectively referred to herein as a mass storage 410.

Software 411 for execution on the computer system 400 may be stored in the mass storage 410. The mass storage 410 is an example of a tangible storage medium readable by the processors 401, where the software 411 is stored as instructions for execution by the processors 401 to cause the computer system 400 to operate, such as is described herein below with respect to the various Figures. Examples of computer program product and the execution of such instruction is discussed herein in more detail. The communications adapter 407 interconnects the system bus 402 with a network 412, which may be an outside network, enabling the computer system 400 to communicate with other such systems. In one embodiment, a portion of the system memory 403 and the mass storage 410 collectively store an operating system, which may be any appropriate operating system, such as the z/OS or AIX operating system from IBM Corporation, to coordinate the functions of the various components shown in FIG. 4.

Additional input/output devices are shown as connected to the system bus 402 via a display adapter 415 and an interface adapter 416 and. In one embodiment, the adapters 406, 407, 415, and 416 may be connected to one or more I/O buses that are connected to the system bus 402 via an intermediate bus bridge (not shown). A display 419 (e.g., a screen or a display monitor) is connected to the system bus 402 by a display adapter 415, which may include a graphics controller to improve the performance of graphics intensive applications and a video controller. A keyboard 421, a mouse 422, a speaker 423, etc. can be interconnected to the system bus 402 via the interface adapter 416, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 4, the computer system 400 includes processing capability in the form of the processors 401, and, storage capability including the system memory 403 and the mass storage 410, input means such as the keyboard 421 and the mouse 422, and output capability including the speaker 423 and the display 419.

In some embodiments, the communications adapter 407 can transmit data using any suitable interface or protocol, such as the internet small computer system interface, among others. The network 412 may be a cellular network, a radio network, a wide area network (WAN), a local area network (LAN), or the Internet, among others. An external computing device may connect to the computer system 400 through the network 412. In some examples, an external computing device may be an external webserver or a cloud computing node.

It is to be understood that the block diagram of FIG. 4 is not intended to indicate that the computer system 400 is to include all of the components shown in FIG. 4. Rather, the computer system 400 can include any appropriate fewer or additional components not illustrated in FIG. 4 (e.g., additional memory components, embedded controllers, modules, additional network interfaces, etc.). Further, the embodiments described herein with respect to computer system 400 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discreet logic circuit(s) having logic gates for implementing logic functions upon data signals, an application specific integrated circuit (ASIC) having appropriate combinational logic gates, a programmable gate array(s) (PGA), a field programmable gate array (FPGA), etc

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method for controlling instant message notifications, the method comprising:
receiving an instant message for a user;
determining a logical coherence state of user actions;
determining an importance score for the instant message and for a current user action;
determining one or more conditions for displaying the instant message to the user based on the logical coherence state of user actions, the importance score of the instant message and the importance score of the current user action; and
displaying the instant message to the user upon the one or more conditions being met.

2. The method of claim 1, wherein a manner in which the instant message is displayed is determined based upon which of the one or more conditions are met.

3. The method of claim 1, wherein determining the logical coherence state of user actions includes analyzing a state of user interaction with one or more applications.

4. The method of claim 4, wherein the logical coherence state of user interaction with one or more applications indicates whether an incomplete user action exists for the one or more applications.

5. The method of claim 1, wherein determining the importance score of the instant message includes analyzing a text of the instant message.

6. The method of claim 1, wherein determining the importance score of the instant message includes analyzing a relationship between a sender of the instant message and the user.

7. The method of claim 1, wherein the one or more conditions are obtained from a user profile of the user.

8. A system comprising:
one or more processors for executing computer-readable instructions, the computer-readable instructions controlling the one or more processors to perform operations comprising:
receiving an instant message for a user;
determining a logical coherence state of user actions;
determining an importance score for the instant message and for a current user action;
determining one or more conditions for displaying the instant message to the user based on the logical coherence state of user actions, the importance score of the instant message and the importance score of the current user action; and
displaying the instant message to the user upon the one or more conditions being met.

9. The system of claim 8, wherein a manner in which the instant message is displayed is determined based upon which of the one or more conditions are met.

10. The system of claim 8, wherein determining the logical coherence state of user actions includes analyzing a state of user interaction with one or more applications.

11. The system of claim 10, wherein the logical coherence state of user interaction with one or more applications indicates whether an incomplete user action exists for the one or more applications.

12. The system of claim 8, wherein determining the importance score of the instant message includes analyzing a text of the instant message.

13. The system of claim 8, wherein determining the importance score of the instant message includes analyzing a relationship between a sender of the instant message and the user.

14. The system of claim 8, wherein the one or more conditions are obtained from a user profile of the user.

15. A computer program product comprising a computer-readable storage medium having program instructions embodied therewith, the program instructions executable by a processor to cause the processor to perform operations comprising:
receiving an instant message for a user;
determining a logical coherence state of user actions;
determining an importance score for the instant message and for a current user action;
determining one or more conditions for displaying the instant message to the user based on the logical coherence state of user actions, the importance score of the instant message and the importance score of the current user action; and
displaying the instant message to the user upon the one or more conditions being met.

16. The computer program product of claim 15, wherein a manner in which the instant message is displayed is determined based upon which of the one or more conditions are met.

17. The computer program product of claim 15, wherein determining the logical coherence state of user actions includes analyzing a state of user interaction with one or more applications.

18. The computer program product of claim 17, wherein the logical coherence state of user interaction with one or more applications indicates whether an incomplete user action exists for the one or more applications.

19. The computer program product of claim 15, wherein determining the importance score of the instant message includes analyzing a text of the instant message.

20. The computer program product of claim 15, wherein determining the importance score of the instant message includes analyzing a relationship between a sender of the instant message and the user.
